(19) United States
(12) Patent Application Publication
(10) Pub. No.: US 2024/0393669 A1
(43) Pub. Date: Nov. 28, 2024

(54) Baffle

(71) Applicant: LiMES - IMMERSIVE SOLUTIONS GMBH, Wien (AT)

(72) Inventors: Heinrich Schlaefer, Wien (AU); Peter Willensdorfer, Wien (AU)

(73) Assignee: LiMES - IMMERSIVE SOLUTIONS GMBH, Wien (AT)

(21) Appl. No.: 18/693,574

(22) PCT Filed: Sep. 15, 2022
(86) PCT No.: PCT/EP2022/075631

§ 371 Date: Mar. 20, 2024

(30) Foreign Application Priority Data
Sep. 23, 2021 (DE) 10 2021 124 624.5

(51) Int. Cl. G03B 21/56; G03B 21/00; H04R 1/02; H04R 1/28

(52) U.S. Cl. CPC G03B 21/565; G03B 21/006; H04R 1/025; H04R 1/2803; H04R 2499/15

(57) ABSTRACT

A baffle includes a plate-shaped support structure, which is made of an at least partially air-permeable and at least partially sound-absorbing material and which has a first surface, a second surface facing away from the first surface, a thickness, and a cut-out portion. The baffle further includes a frame structure, to which the support structure is fastened, an at least partially sound-transparent layer, which is applied to the entire first surface of the support structure and which forms, in particular, a projection surface for projecting an image thereon or which is an imaging layer for displaying an image, and an acoustic transducer, which is arranged in the cut-out portion behind the layer, generates sound and is able to emit the sound through the layer.

### CROSS-REFERENCE TO RELATED APPLICATIONS

This application is a national phase application under 35 U.S.C. § 371 of International Patent Application No. PCT/EP2022/075631, filed Sep. 15, 2022 (pending), which claims the benefit of priority to German Patent Application No. DE 10 2021 124 624.5, filed Sep. 23, 2021, the disclosures of which are incorporated by reference herein in their entirety.

### TECHNICAL FIELD

The invention relates to a baffle with an integrated acoustic transducer.

### BACKGROUND

EP 1 078 300 B1 discloses a projection screen having a projection surface formed from segments, of which at least two segments are sound emission segments with which sound waves can be emitted from the projection surface. The projection surface is provided for an image to be projected thereon. The image is projected onto the projection surface using a projector, for example. It is thereby possible, for example, to project a film onto the projection surface by means of a sequence of images. At least one acoustic transducer is required for the sound associated with the film.

### SUMMARY

The object of the present invention is to provide an improved baffle, in particular a projection screen with an integrated acoustic transducer.

The object of the invention is achieved by a baffle having a plate-shaped support structure, which is made of an at least partially air-permeable and at least partially sound-absorbing material and has a first surface, a second surface facing away from the first surface, a thickness, and a cut-out portion, a frame structure to which the support structure is fastened, an at least partially sound-transparent layer, which is applied to the entire first surface of the support structure, and an acoustic transducer, which is arranged in the cut-out portion behind the layer, generates sound and is able to emit the sound through the layer. The layer is in particular a projection surface for projecting an image thereon or an imaging layer for displaying an image.

A further aspect of the invention relates to a modular baffle device, having a plurality of baffles according to the invention, which are designed as baffle modules and are arranged next to one another, in particular in a matrix-like manner, in order to form the modular baffle device, and in particular the layers of the baffle modules together form an overall projection surface or an overall imaging layer for displaying an image. “Next to one another” means not only that the baffle modules are arranged next to one another horizontally but also that the acoustic transducers can be arranged next to one another in the vertical direction.

A further aspect of the invention relates to a device having the baffle according to the invention or the modular baffle device according to the invention, a projector for projecting a series of images onto the projection surface, and a control device connected to the acoustic transducer or the acoustic transducers and to the projector and controlling same, so that the sound emitted by the acoustic transducer or the acoustic transducers is synchronous with the series of images.

A further aspect of the invention relates to a device having the baffle according to the invention or the modular baffle device according to the invention, wherein the layer or the layers is or are designed as an imaging layer or as imaging layers, and a control device, which is connected to the acoustic transducer or the acoustic transducers and to the imaging layer or the imaging layers and is configured to control the acoustic transducer(s) and the imaging layer or layers in such a way that the sound emitted by the acoustic transducer or the acoustic transducers is synchronous with a series of images displayed with the imaging layer or the imaging layers.

The baffle according to the invention accordingly comprises the plate-shaped support structure made of an at least partially air-permeable and at least partially sound-absorbing material, the frame device, and the acoustic transducer. The frame device is preferably self-supporting and is in particular stable in such a way that it can carry the mass of the support structure, the acoustic transducer, and the layer.

The baffle is in particular rectangular and has, for example, side lengths of 0.6 m to 3.0 m.

The acoustic transducer is arranged in the cut-out portion in the support structure. It can be provided for the acoustic transducer to be fastened directly to the support structure or to the frame device.

The frame device can also have at least one transverse strut and/or at least one longitudinal strut for increasing the rigidity or load-bearing capacity.

The frame device is made of, for example, wood, plastics material or metal, for example aluminum.

The acoustic transducer is, for example, an acoustic transducer according to the beamforming or beam steering principle. Preferably, the acoustic transducer is a BMR (balanced mode radiator) acoustic transducer or, in particular, a DML (distributed mode loudspeaker) acoustic transducer. This type of acoustic transducer can be designed to be relatively flat and thus can be arranged relatively easily in the cut-out portion in the support structure. In combination with the support structure, relatively good, even very good, acoustic properties of the baffle can also result.

For a relatively good, even very good, acoustic property, the material of the support structure is at least partially, preferably largely air-permeable and at least partially, preferably largely, sound-absorbing.

Preferably, the material of the support structure is such that it absorbs sound at least in a frequency range above 50 Hz, in particular above 90 Hz, and/or with an absorption coefficient of α>0.5, preferably α>0.8. The emission of sound at lower frequencies than approximately 50 or 90 Hz can be influenced, for example, by using sound absorbers as are known in principle to a person skilled in the art, for example in the form of bass traps. Further sound absorbers can, for example, be fastened to the rear side, i.e., the second surface of the baffle, or integrated into the frame device.

The sound-absorbing properties of the support structure can be adjusted, for example, by the choice of material, but also by the thickness of the support structure. The material used can preferably be expanded glass or PET or a combination of these materials, or the material of the support structure can contain expanded glass or PET or a combination of these materials.

The thickness of the support structure is preferably between 15 mm and 100 mm. This results in relatively favorable acoustic properties, while the baffle according to the invention remains relatively easy to transport.

The baffle according to the invention is possibly not only intended to emit sound, in particular music or speech, by means of the acoustic transducer, but also in particular for visual representation. For this purpose, the baffle according to the invention comprises the layer arranged on the first surface of the support structure. The layer is designed such that it is completely arranged on the first surface, i.e., covers the first surface of the support structure also in the region of the cut-out portion.

The layer is at least partially permeable to sound, i.e., at least partially sound-transparent, preferably sound-transparent as far as possible, so that the acoustic transducer arranged in the cut-out portion in the support structure is able to emit its sound through the layer as unhindered as possible, i.e., is distorted as little as possible by the layer.

This is achieved in particular in that the layer is designed to be as thin as possible, for example has a thickness of less than 3 mm, or has a thickness between 0.1 mm and 3 mm. The thickness of the layer can influence its permeability to sound.

For relatively good, even very good, acoustic properties, the layer is in particular not acoustically hard as far as possible.

According to one embodiment of the baffle according to the invention, the layer is designed as a projection surface for projecting an image thereon. Suitable materials for such a layer are, for example, cellulose plaster, a relatively thin laminate layer, or woven fabric made of PET. Such a layer can, for example, also be applied to the support structure after the latter is provided with the cut-out portion. However, it is also possible for this layer to be already applied to the support structure before the cut-out portion is produced.

The color of the layer can be adapted, possibly optimized, to the intended projection environment or type.

Alternatively, the layer is an imaging layer, i.e., is configured to actively display an image or a series of images. This can be realized, for example, by the layer formed as an imaging layer having QLEDs, OLEDs or LCDs, which are in particular woven into a fabric or glued thereon.

The frame device and the material of the support structure are connected to one another. The material of the support structure can, for example, lie entirely within the frame device. The layer then preferably extends over the frame device. However, the material of the support structure can also stand above the frame device and then terminate flush therewith at the side.

According to one embodiment of the baffle according to the invention, the cut-out portion in the support structure is designed as a continuous opening which the layer completely covers. This opening can be cut out, for example, into the support structure.

According to an alternative embodiment of the baffle according to the invention, the support structure is designed in the region of the cut-out portion as an indentation that is accessible from the second surface of the support structure and the thickness of which in the region of the first surface is much smaller than the thickness of the rest of the support structure, so that the acoustic transducer is able to at least partially emit its sound through this part of the support structure and the layer. The indentation can be produced, for example, by milling, so that a layer of the support material remains. The cut-out portion or the milled portion is preferably slightly larger than the acoustic transducer in order to prevent or at least reduce any direct vibration transmission between acoustic transducers.

Due to the relative low strength or thickness of the layer and the possible installation of the acoustic transducer directly therebehind, it is made possible, in the case of image reproduction, to reduce or even prevent a depth offset that leads to a difference between the viewing angle of the image object and the angle relative to the sound-emitting surface of the acoustic transducer. This applies in particular to the transverse plane (hearing in the horizontal plane), since any deviation can be heard most easily here.

The baffle according to the invention preferably has a relatively low structural depth.

The deflection of a membrane of the acoustic transducer, corresponding to an air flow or a housing of the acoustic transducer, should excite the support structure to oscillate as little as possible or not at all in order to ensure interference-free image reproduction with different projector optics. This can be achieved, for example, by a correspondingly rigid construction of the frame device.

The first surface can be planar or curved, in particular continuously curved, preferably twice curved or twice continuously curved. It is thereby possible in particular to provide a curved, in particular a twice curved projection surface or imaging surface. In particular the curved design can be produced relatively easily due to the support structure, whereby different image reproductions are possible.

According to one embodiment of the baffle according to the invention, the support structure comprises a plurality of plate-shaped support structure segments arranged next to one another in order to form at least one approximately curved first surface. Preferably, the layer is then designed such that it forms a continuously curved, preferably twice continuously curved projection surface.

However, the first surface facing the layer can, for example, also be milled off in such a way that the individual support structure segments assume a curved, preferably twice curved shape. In the case of the imaging layer, it can also be designed in such a way that it can display a curved, in particular twice curved, image.

As already mentioned, the invention relates to the modular baffle device, having a plurality of baffles according to the invention designed as baffle modules. The individual baffle modules are arranged next to one another, for example fastened next to one another by means of fastening means, so that the layers of the baffle modules together form the overall projection surface or the overall imaging layer for displaying an image. Due to the modularization, differently sized and/or differently constructed baffle devices can be assembled.

According to a variant of the modular baffle device according to the invention, it has at least one module without an acoustic transducer, which module comprises a further frame device, a further support structure, in particular without a cut-out portion, the material of which corresponds to the material of the support structure of the baffle modules, and a further layer, which is applied to the entire surface of the further support structure and corresponds to the layer of the baffle modules, so that the module without an acoustic transducer and the baffle modules together can form the modular baffle device. The module without an acoustic transducer thus does not comprise an acoustic transducer.

In particular, the individual baffle modules and, if applicable, the modules without an acoustic transducer can have different sizes and shapes (planar, once and twice curved). In order to achieve the different shapes, a rib substructure can be used.

In order to achieve continuity in single and double curves, a support material that is not sufficiently flexible can be segmented, for example, in order to obtain plate-shaped support structure segments. These are, for example, connected to one another and then introduced into the frame device. An approximation of the curve can also be achieved and the segmented support structure can be kept in shape with the aid of the rib substructure. Exact continuity can then be achieved via the application of the layer, which is able to compensate for the discontinuities of the segmentation resulting from different thicknesses.

The baffle or the baffle module can comprise a single acoustic transducer or a plurality of acoustic transducers. If the baffle or the baffle module comprises a plurality of acoustic transducers, the baffle or the baffle module can correspondingly comprise a plurality of cut-out portions. It can also be provided for two or more acoustic transducers to be arranged in a cut-out portion.

For applications in which image reproduction is not desired/necessary, the layer can be printed. The system can thus also be designed as a purely absorbing, modular free-form system. Cut-out portions are possible (for example for doors), the doors can be designed as independent modules.

The modules can be connected to one another to form different shapes (e.g., cuboids, domes, amorphous walls). The modules can be connected to one another either directly or via a load-bearing primary structure (for example in the case of large installations or high static loads, such as the cantilevering of crossbeams).

As a result of the design as a modular baffle device, temporary as well as fixed structures are also made possible, since the modules can be reused and freely combined with one another/among one another. This also reduces the CO2 impact for structures of this type.

As a result of the combination of free forms and the described absorbing, (electro) acoustic and image-reproducing properties of the modules, any desired wall shapes (planar, amorphous, etc.) and cubatures (cuboids, cylinders, domes, etc.) can be realized without disadvantageous acoustic effects such as flutter echoes. In this type of expanded space, adaptive/immersive/3D acoustics can thus be combined with a frontal or in particular 360° image reproduction (e.g., immersive theater/immersive concert halls, simulation spaces, planetariums, etc.).

Exemplary embodiments of the invention are shown by way of example in the accompanying schematic drawings.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a first exemplary embodiment of a baffle in an exploded diagram,

FIG. 2 is a side view of the baffle of FIG. 1 in a sectional diagram,

FIG. 3 depicts an alternative design of the baffle of FIG. 1 in a sectional diagram,

FIG. 4 depicts a second embodiment of a baffle in an exploded diagram,

FIG. 5 is a side view of the baffle of FIG. 4 in a sectional diagram,

FIG. 6 depicts an alternative design of the baffle of FIG. 4 in a sectional diagram,

FIGS. 7a, 7b depict an embodiment of a baffle having a once curved surface in a perspective diagram,

FIG. 8 depicts an embodiment of a baffle having a twice curved surface in a perspective diagram, and

FIGS. 9-14 depict modular baffle devices having a plurality of baffle modules designed as baffles.

### DETAILED DESCRIPTION

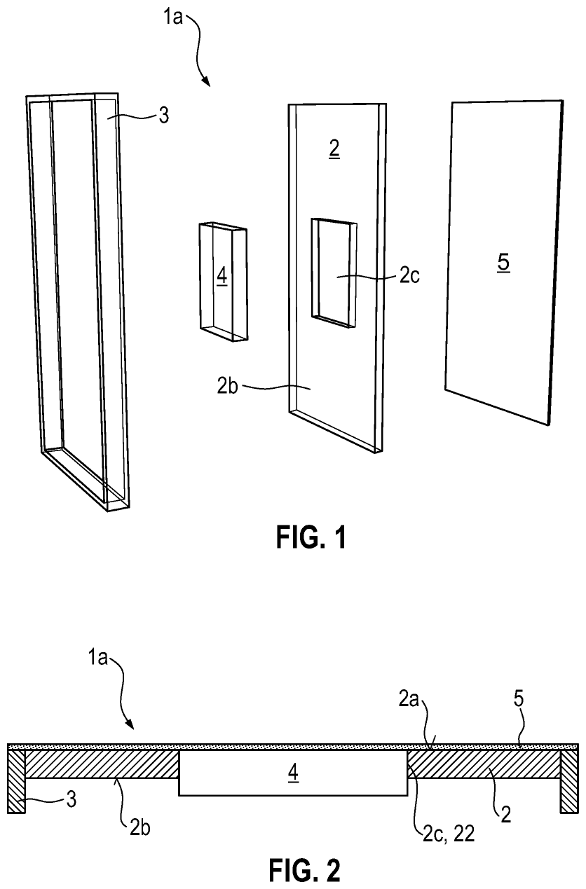

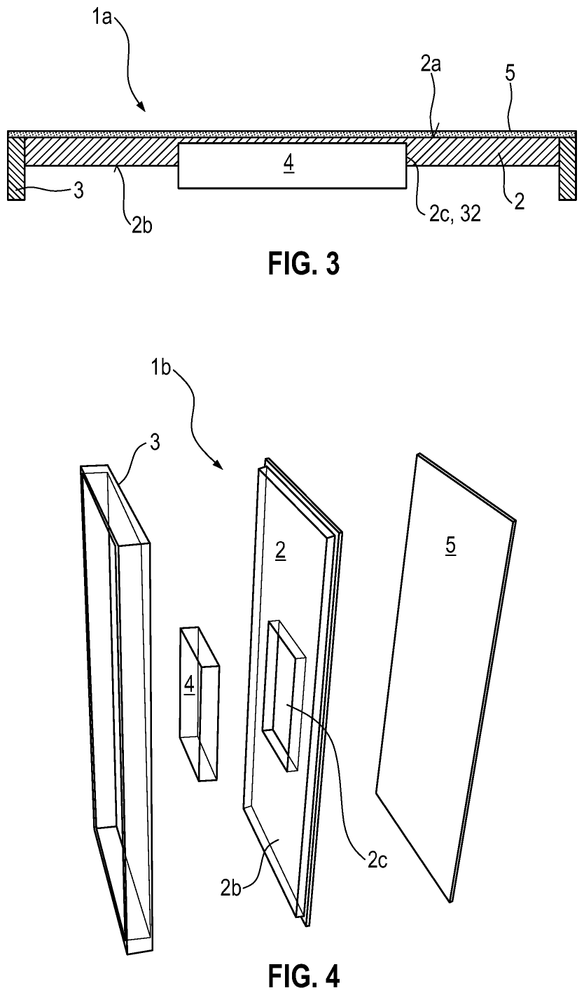

FIG. 1 shows a first exemplary embodiment of a baffle 1a in an exploded diagram, and FIG. 2 is a side view of the baffle 1a in a sectional diagram. FIG. 3 shows an alternative design of the baffle 1a in a sectional diagram.

The baffle 1a comprises a plate-shaped support structure 2 made of an at least partially air-permeable and at least partially sound-absorbing material, a frame device 3, an acoustic transducer 4, and a layer 5.

The plate-shaped support structure 2 comprises a first surface 2a to which the layer 5 is applied or fastened, and a second surface 2b, which faces away from the first surface 2a and in particular forms the rear side of the baffle 1a.

The support structure 2 is arranged on or fastened to the frame device 3. In the case of the present exemplary embodiment, the frame device 3 completely borders the support structure 2, and the layer 5 extends over the frame device 3 in such a way that it terminates flush with the frame device 3.

The frame device 3 is made of, for example, wood, plastics material or metal, for example aluminum.

The frame device 3 is preferably self-supporting and is in particular stable in such a way that it can support the mass of the support structure 2, the acoustic transducer 4, and the layer 5.

The baffle 1a is in particular rectangular and has, for example, side lengths of 0.6 m to 3.0 m.

In the case of the present exemplary embodiment, the material of the plate-shaped support structure 2 is such that it absorbs sound at least in a frequency range above 50 Hz, in particular above 90 Hz, and/or with an absorption coefficient of α>0.5, preferably α>0.8. The emission of sound at lower frequencies than approximately 50 or 90 Hz can be influenced, for example, by using sound absorbers (not shown) as are known in principle to a person skilled in the art, for example in the form of bass traps. Further sound absorbers can, for example, be fastened to the rear side, i.e., the second surface 2b, or integrated into the frame device 3.

The sound-absorbing properties of the support structure 2 can be adjusted, for example, by the choice of material, but also by the thickness of the support structure 2. In the case of the present exemplary embodiment, the material used is expanded glass or PET or a combination of these materials.

In the case of the present exemplary embodiment, the thickness of the support structure 2 is between 15 mm and 100 mm.

The support structure 2 comprises a cut-out portion 2c in which the acoustic transducer 4 is arranged, in the case of the present exemplary embodiment is fastened to the support structure 2. However, it is also possible for the acoustic transducer 4 to be fastened to the frame device 3. For this purpose, the latter comprises, for example, a transverse or longitudinal strut (not shown).

The acoustic transducer 4 is, for example, an acoustic transducer according to the beamforming or beam steering principle. In the case of the present exemplary embodiment, the acoustic transducer 4 is a BMR (balanced mode radiator) acoustic transducer or preferably a DML (distributed mode loudspeaker) acoustic transducer.

The cut-out portion 2c can be designed, for example, as an opening 22, as shown in FIG. 2. In this case, the layer 5 extends over the opening 22.

The layer 5 is at least partially permeable to sound, so that the acoustic transducer 4 is able to emit the sound generated thereby through the layer 5.

The cut-out portion 2c can also be designed as an indentation 32, as shown in FIG. 3. In this case, the thickness of the support structure 2 in the region of the cut-out portion 2c or indentation 32 is smaller than the remaining thickness of the support structure 2, so that the acoustic transducer 4 is able to emit the sound generated thereby through the support structure 2 in the region of the cut-out portion 2c or in the region of the indentation 32 and through the layer 5. The indentation 32 is accessible via the rear side of the baffle 1a or via the second surface 2b of the support structure 2.

In the case of the present exemplary embodiment, the baffle 1a is not only intended to emit sound, in particular music or speech, by means of the acoustic transducer 4, but also for visual representation. For this purpose, the baffle 1a comprises the layer 5 arranged on the first surface 2a of the support structure 2. The layer 5 is in particular designed such that it is completely arranged on the first surface 2a, i.e., covers the first surface 2a of the support structure 2 also in the region of the cut-out portion 2c.

The layer 5 is designed to be as thin as possible and has, for example, a thickness of less than 3 mm. In the case of the present exemplary embodiment, the layer 5 is not acoustically hard as far as possible.

In the case of the present exemplary embodiment, the layer 5 forms a projection surface for projecting an image thereon and is manufactured, for example, from a cellulose plaster, a relatively thin laminate layer or from a woven fabric made of PET.

The color of the layer 5 can be adapted, possibly optimized, to the intended projection environment or type.

Alternatively, the layer 5 is an imaging layer, i.e., is configured to actively display an image or a series of images. In the case of the present exemplary embodiment, this is realized by the layer 5 formed as an imaging layer having QLEDs, OLEDs or LCDs, which are, for example, woven into a fabric or glued thereon.

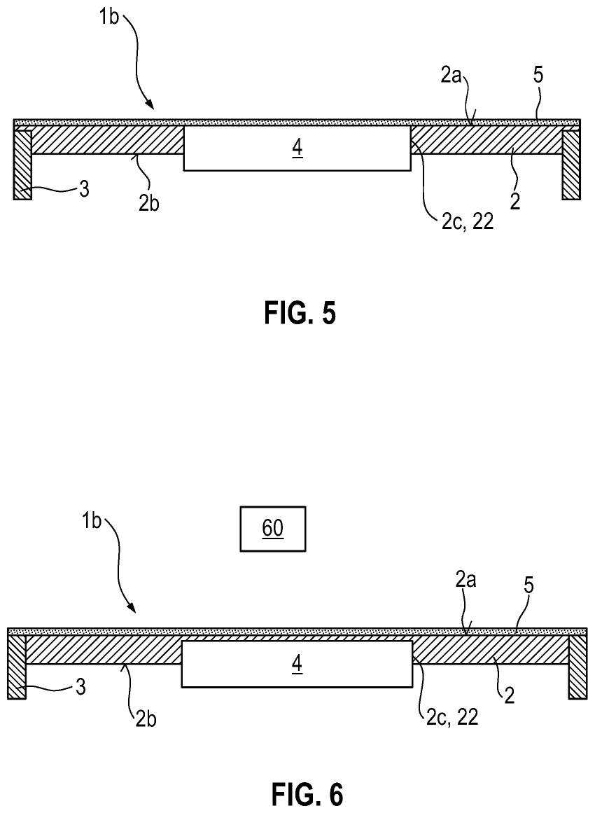

FIG. 4 shows a second embodiment of a baffle 1b in an exploded diagram, and FIG. 5 is a side view of the baffle 1b in a sectional diagram. FIG. 6 shows an alternative design of the baffle 1b in a sectional diagram.

The baffle 1b shown in FIGS. 4 to 6 differs substantially from the baffle 1a shown in FIGS. 1 to 3 in that the support structure 2 overlaps the frame device 3 at the front and runs flush with the frame device 3 at the side.

The support structure 2 of the variant of the baffle 1b shown in FIG. 5 comprises the cut-out portion 2c formed as an opening 22, and the support structure 2 of the variant of the baffle 1b shown in FIG. 6 comprises the cut-out portion 2c formed as an indentation 32.

In the exemplary embodiments shown in FIGS. 1 to 6, the first surfaces 2a and thus the projection surfaces or the imaging layers of the baffles 1a, 1b are planar.

The first surface 2a or the layer 5 can also be curved, in particular twice curved.

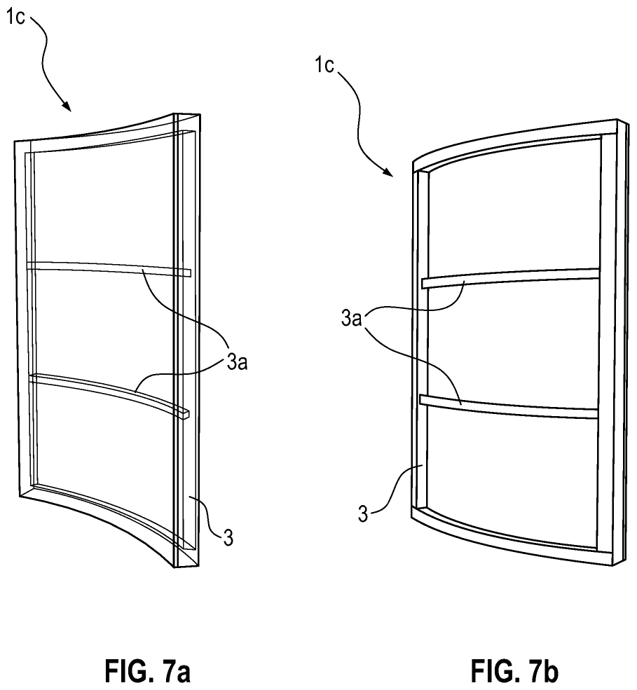

FIGS. 7a and 7b show an embodiment of a baffle 1c with a curved first surface 2a in a perspective diagram. The curved first surface 2a is in particular curved once. FIG. 7a shows the front and FIG. 7b shows the rear view of the baffle 1c.

The frame device 3 of the baffle 1c shown in FIG. 7a, 7b is manufactured with a rib substructure, so that, in the case of the present exemplary embodiment, the frame device 3 comprises a plurality of bent or curved transverse struts 3a.

FIG. 8 shows a further embodiment of a baffle 1d. This differs from the baffles 1a, 1b shown in FIGS. 1 to 6 substantially in that the support structure 2 comprises a plurality of plate-shaped support structure segments 82 arranged next to one another in order to form at least one approximately curved, in particular twice curved, first surface 1a.

In the case of the present exemplary embodiment, the layer 5 can be designed in such a way that it forms a curved, preferably a twice curved, optionally continuously curved or twice continuously curved projection surface. In the case of the imaging layer, it can also be designed in such a way that it can display a curved, in particular twice curved, image.

The baffles 1a, 1b, 1c, 1d shown in FIGS. 1 to 8 can be designed as acoustic transducer modules, so that a plurality of acoustic transducer modules arranged next to one another form a baffle device. The individual baffle modules are arranged next to one another, for example fastened next to one another by means of fastening means, so that the layers 5 of the baffle modules together form an overall projection surface or an overall imaging layer for displaying an image. Due to the modularization, differently sized and/or differently constructed baffle devices can be assembled.

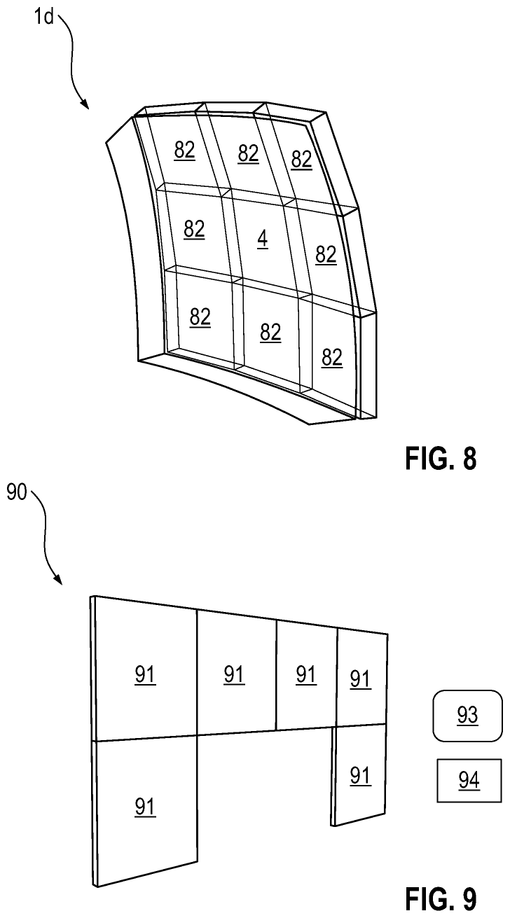

FIGS. 9 to 14 show examples of such baffle devices 90, which each have a plurality of baffles 1a to d designed as acoustic transducer modules 91. The baffle devices 90 can also have at least one module 92 without an acoustic transducer, which module comprises a further frame device, a further support structure, in particular without a cut-out portion, the material of which corresponds to the material of the support structure 2 of the baffle modules, and a further layer which is applied to the entire surface of the further support structure and corresponds to the layer 5 of the baffle modules 91, so that the module 92 without an acoustic transducer and the baffle modules 91 together can form the modular baffle device.

In particular, the individual baffle modules 91 and, if applicable, the modules 92 without an acoustic transducer can have different sizes and shapes (planar, once and twice curved). In order to achieve the different shapes, a rib substructure can be used.

The baffle device 90 shown in FIG. 9 comprises, for example, six baffle modules 91, which are designed, for example, in accordance with the baffles 1a, 1b shown in FIGS. 1 to 3 or 4 to 6.

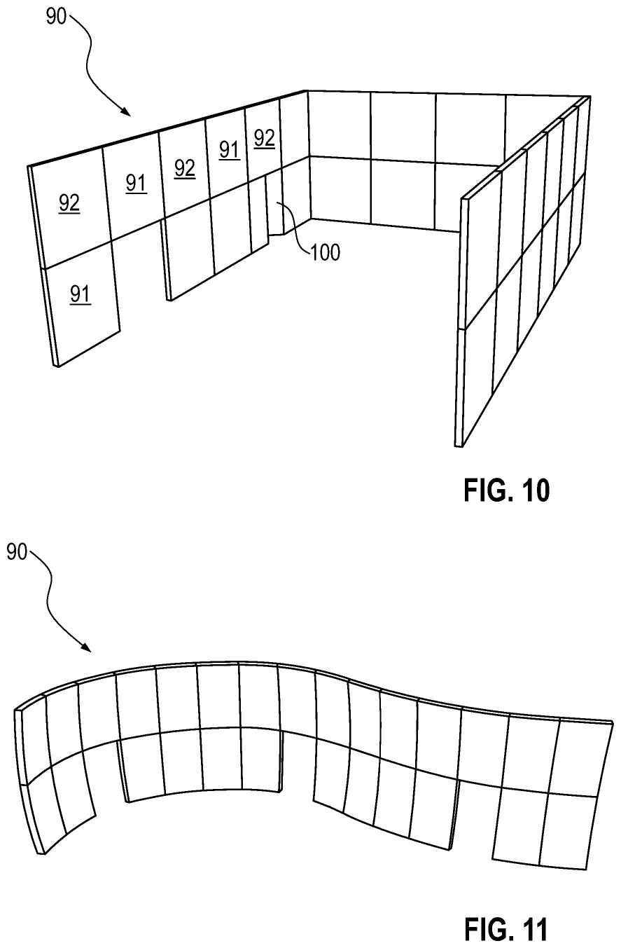

The baffle device 90 shown in FIG. 10 comprises, for example, a plurality of baffle modules 91, which are designed, for example, in accordance with the baffles 1a, 1b shown in FIGS. 1 to 3 or 4 to 6, and a plurality of modules 92 without an acoustic transducer. This is in particular a room to the walls of which the baffle device 90 is fastened. The room can be entered by means of a door 100. The door 100 can also be provided with a baffle module 91 or with a module 92 without an acoustic transducer.

The baffle device 90 shown in FIG. 10 comprises, for example, a plurality of baffle modules 91, which are designed, for example, in accordance with the baffles 1c, d shown in FIG. 7a, 7b, or 8.

The baffle device 90 shown in FIG. 11 comprises, for example, a plurality of baffle modules 91, which are designed, for example, in accordance with the baffles 1c, d shown in FIG. 7a, 7b, or 8. This baffle device 90 has the shape of an amorphous wall with passages.

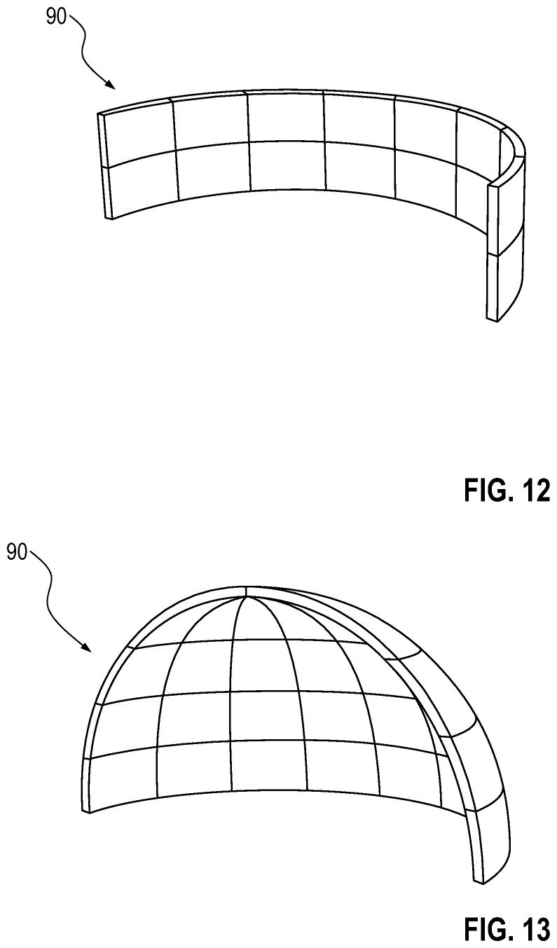

The baffle device 90 shown in FIG. 12 comprises, for example, a plurality of baffle modules 91, which are designed, for example, in accordance with the baffle 1c shown in FIG. 7a, 7b. This baffle device 90 has the shape of a partial cylinder.

The baffle device 90 shown in FIG. 13 comprises, for example, a plurality of baffle modules 91, which are designed, for example, in accordance with the baffles 1c, d shown in FIG. 7a, 7b, or 8. This baffle device 90 is dome-shaped.

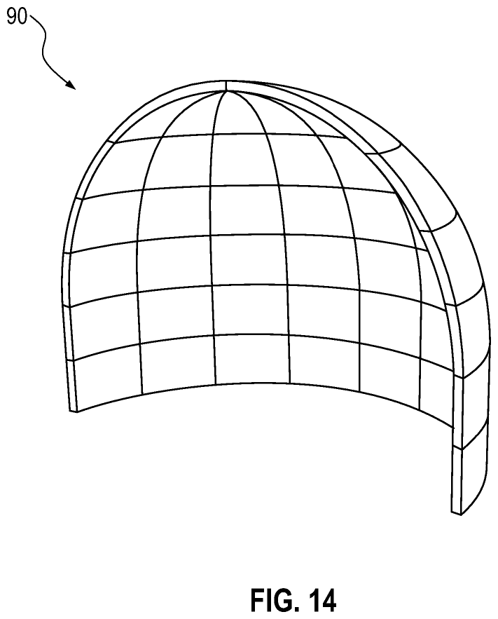

The baffle device 90 shown in FIG. 14 comprises, for example, a plurality of baffle modules 91, which are designed, for example, in accordance with the baffles 1c, d shown in FIG. 7a, 7b, or 8. This baffle device 90 is dome-shaped in its upper region and cylindrical in its lower region.

If the layers 5 are designed as projection surfaces, the baffles 1a to 1d or the baffle devices 90 can be combined with a projector 93 shown in FIG. 9 for projecting a series of images onto the projection surface or the overall projection surface, and with a control device 94 connected to the acoustic transducer 4 or to the acoustic transducers 4 and to the projector 93 and controlling same, so that the sound emitted by the acoustic transducer 4 or the acoustic transducers 4 is synchronous with the series of images.

If the layers 5 are imaging layers, then the baffles 1a to 1d or the baffle devices 90 can be combined with a control device 60 shown in FIG. 6, which controls the imaging layer or layers and the acoustic transducers 4 or the acoustic transducers 4 in such a way that the sound emitted by the acoustic transducer 4 or the acoustic transducers 4 is synchronous with a series of images displayed with the imaging layer or the imaging layers.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1-11. (canceled)

12. A baffle, comprising:
a plate-shaped support structure made of an at least partially air-permeable and at least partially sound-absorbing material, the support structure having a first surface, a second surface facing away from the first surface, a thickness, and an opening;
a frame structure to which the support structure is fastened;
an at least partially sound-transparent layer applied to the entire first surface of the support structure and which forms a projection surface adapted for projecting an image thereon, or which is an imaging layer for displaying an image; and
an acoustic transducer arranged in the opening behind the sound-transparent layer, the acoustic transducer configured to generate sound such that the sound is emitted through the sound-transparent layer.

13. The baffle of claim 12, wherein at least one of:
the material of the support structure absorbs sound at least in a frequency range above 50 Hz;
the material of the support structure has a sound absorption coefficient of α>0.5;
the support structure has a thickness is between 15 mm and 100 mm; or
the material of the support structure comprises expanded glass, polyethylene terephthalate (PET), or a combination of expanded glass and PET.

14. The baffle of claim 13, wherein at least one of:
the material of the support structure absorbs sound at least in a frequency range above 90 Hz; or
the material of the support structure has a sound absorption coefficient of α>0.8.

15. The baffle of claim 12, wherein at least one of:
the sound-transparent layer is designed as a cellulose plaster, as a laminate layer, or as a woven fabric made of PET; or
the sound-transparent layer has a thickness between 0.1 mm and 3 mm.

16. The baffle of claim 12, wherein the sound-transparent layer is configured as an imaging layer and includes QLEDs, OLEDs, or LCDs.

17. The baffle of claim 16, wherein the QLEDs, OLEDs, or LCDs are at least one of woven into a fabric or glued onto a fabric.

18. The baffle of claim 12, wherein one of:
the opening of the support structure is configured as a through-opening which is completely covered by the sound-transparent layer; or
the support structure is configured in the region of the opening as a recess that is accessible from the second surface of the support structure, and the thickness of the support structure in the region of the first surface is much smaller than the thickness of the rest of the support structure, such that the acoustic transducer is able to at least partially emit its sound through the sound-transparent layer and the part of the support structure in the region of the opening.

19. The baffle of claim 12, wherein the first surface is planar or is curved.

20. The baffle of claim 19, wherein the first surface is twice curved.

21. The baffle of claim 12, wherein the support structure comprises a plurality of plate-shaped support structure segments arranged next to one another and forming at least one curved first surface.

22. The baffle of claim 21, wherein the sound-transparent layer is configured to form a curved projection surface.

23. A modular baffle device, comprising:
a plurality of baffles according to claim 12;
wherein the plurality of baffles are configured as baffle modules and are arranged next to one another.

24. The modular baffle device of claim 23, wherein at least one of:
the plurality of baffle modules are arranged next to one another in a matrix-like manner in order to form the modular baffle device; or
the sound-transparent layers of the respective baffle modules together form an overall projection surface or an overall imaging layer for displaying an image.

25. The modular baffle device of claim 23, further comprising:
at least one module without an acoustic transducer;
the at least one module without an acoustic transducer comprising:
a further frame device,
a further support structure made of a material corresponding to the material of the support structure of the baffle modules, and
a further layer which is applied to the entire surface of the further support structure and corresponding to the sound-transparent layer of the baffle modules;
the at least one module without an acoustic transducer arranged together with the plurality of baffle modules to form the modular baffle device.

26. An audio-visual system, comprising:
at least one baffle according to claim 12, wherein the at least partially sound-transparent layer of each baffle forms a projection surface adapted for projecting a series of images thereon;
a projector for projecting a series of images onto the projection surface formed by the sound-transparent layer of the at least one baffle; and
a control device operatively communicating with the projector and with at least one acoustic transducer of the at least one baffle, and configured to control the projector and the at least one acoustic transducer such that sound emitted by the at least one acoustic transducer is synchronized with the series of images.

27. An audio-visual system, comprising:
at least one baffle according to claim 12, wherein the at least partially sound-transparent layer of each baffle is an imaging layer; and
a control device operatively communicating with the at least one acoustic transducer and with the at least one imaging layer of the at least one baffle, and configured to control the at least one acoustic transducer and the at least one imaging layer such that sound emitted by the at least one acoustic transducer is synchronized with a series of images displayed by the at least one imaging layer.
